(19) United States
(12) Patent Application Publication
(10) Pub. No.: US 2024/0281689 A1
(43) Pub. Date: Aug. 22, 2024

(54) METHOD FOR PROCESSING QUANTUM COMPUTING TASK, DEVICE, AND STORAGE MEDIUM

(71) Applicant: Beijing Baidu Netcom Science Technology Co., Ltd., Beijing (CN)

(72) Inventors: Zelin Meng, Beijing (CN); Xueyi Guo, Beijing (CN); Zixian Yan, Beijing (CN)

(73) Assignee: Beijing Baidu Netcom Science Technology Co., Ltd., Beijing (CN)

(21) Appl. No.: 18/526,123

(22) Filed: Dec. 1, 2023

(30) Foreign Application Priority Data
Feb. 21, 2023 (CN) 202310188834.9

(51) Int. Cl. G06N 10/20

(52) U.S. Cl. CPC G06N 10/20

(57) ABSTRACT

Provided is a method for processing quantum computing tasks, a device, and a storage medium. The method includes: performing, in a case where a first quantum computing task (QCT) is performed to a pulse compilation stage according to an order in which a plurality of processing stages are performed sequentially, the pulse compilation stage of the first QCT, to obtain an executable pulse sequence of the first QCT, where the first and second QCTs are respectively divided into the plurality of processing stages; sending the executable pulse sequence to a quantum computing device (QCD); performing, according to the order in which the plurality of processing stages are performed, the second QCT in parallel, during performing the plurality of processing stages of the first QCT; and sending an executable pulse sequence of the second QCT to the QCD, in a case of determining the QCD has completed the first QCT.

### CROSS-REFERENCE TO RELATED APPLICATIONS

The present application claims the priority from Chinese Patent Application No. 202310188834.9, filed with the Chinese Patent Office on Feb. 21, 2023, the content of which is hereby incorporated herein by reference in its entirety.

### TECHNICAL FIELD

The present disclosure relates to a field of computer technology, and in particular, to a field of quantum computing.

### BACKGROUND

Quantum computing is a computational model for computing quantum information by following quantum mechanics. Compared to a classical computing device (i.e., an electronic device), the quantum computing is superior to the traditional classical computing device in dealing with some problems. The quantum computing device needs to realize some functions by means of the computing power of classical computing device. A quantum chip in the existing quantum computing device always has idle periods, so that the utilization rate of the quantum computing device still needs to be improved.

### SUMMARY

The present disclosure provides a method and apparatus for processing quantum computing tasks, a device and a storage medium.

According to a first aspect of the present disclosure, provided is a method for processing quantum computing tasks, where each of a first quantum computing task and a second quantum computing task is divided into a plurality of processing stages, based on a parallel pipeline mode, the method including:
performing, in the case where the first quantum computing task is performed to a pulse compilation stage in the plurality of processing stages according to an order in which the plurality of processing stages are performed sequentially, the pulse compilation stage of the first quantum computing task, to obtain an executable pulse sequence of the first quantum computing task;
sending the executable pulse sequence of the first quantum computing task to a quantum computing device;
performing, according to the order in which the plurality of processing stages are performed sequentially, the second quantum computing task in parallel during performing the plurality of processing stages of the first quantum computing task, to obtain an executable pulse sequence of the second quantum computing task in the case of it is performed to the pulse compilation stage; and
sending, in the case of it is determined that the quantum computing device has completed the first quantum computing task, the executable pulse sequence of the second quantum computing task to the quantum computing device.

According to a second aspect of the present disclosure, provided is a method for processing quantum computing tasks, including:
receiving an executable pulse sequence of a first quantum computing task, wherein the first quantum computing task is divided into a plurality of processing stages based on a parallel pipeline mode, and the executable pulse sequence of the first quantum computing task is obtained by performing a pulse compiling stage of the plurality of processing stages; and
performing quantum computing on the first quantum computing task based on the executable pulse sequence of the first quantum computing task.

According to a third aspect of the present disclosure, provided is an apparatus for processing quantum computing tasks, where each of a first quantum computing task and a second quantum computing task is divided into a plurality of processing stages, based on a parallel pipeline mode, the apparatus including:
a processing module, configured to perform, in the case where the first quantum computing task is performed to a pulse compilation stage in the plurality of processing stages according to an order in which the plurality of processing stages are performed sequentially, the pulse compilation stage of the first quantum computing task, to obtain an executable pulse sequence of the first quantum computing task; and
a sending module, configured to send the executable pulse sequence of the first quantum computing task to a quantum computing device,
wherein the processing module is further configured to perform, according to the order in which the plurality of processing stages are performed sequentially, the second quantum computing task in parallel during performing the plurality of processing stages of the first quantum computing task, to obtain an executable pulse sequence of the second quantum computing task in the case of it is performed to the pulse compilation stage; and
the sending module is further configured to send the executable pulse sequence of the second quantum computing task to the quantum computing device in the case of it is determined that the quantum computing device has completed the first quantum computing task.

According to a fourth aspect of the present disclosure, provided is an apparatus for processing quantum computing tasks, including:
a receiving module, configured to receive an executable pulse sequence of a first quantum computing task, wherein the first quantum computing task is divided into a plurality of processing stages based on a parallel pipeline mode, and the executable pulse sequence of the first quantum computing task is obtained by performing a pulse compiling stage of the plurality of processing stages; and
an execution module, configured to perform quantum computing on the first quantum computing task based on the executable pulse sequence of the first quantum computing task.

According to a fifth aspect of the present disclosure, provided is an electronic device, including: at least one processor; and a memory connected in communication with the at least one processor. The memory stores an instruction executable by the at least one processor, and the instruction, when executed by the at least one processor, enables the at least one processor to execute the method according to the first aspect in the embodiment of the present disclosure.

According to a sixth aspect of the present disclosure, provided is a quantum computing device, including: at least one quantum processing unit (QPU); and a memory coupled to the at least one QPU and configured to store an executable instruction. The instruction are executable by the at least one QPU to enable the at least one QPU to execute the method according to the second aspect in the embodiment of the present disclosure.

According to a seventh aspect of the present disclosure, provided is a non-transitory computer-readable storage medium storing a computer instruction thereon, and the computer instruction is used to cause a computer to execute the method of any embodiment of the present disclosure.

According to another aspect of the present disclosure, provided is a computer program product including a computer program, and the computer program implements the method of any embodiment of the present disclosure, when executed by a processor.

In the embodiments of the disclosure, the process of the quantum computing task is parallelized by adopting a parallel pipeline mode, so that the processing efficiency of the quantum computing task is improved, the waiting time of the quantum computing device is reduced, and the utilization rate of the quantum computing device is improved. By sequentially sending the pulse sequences, the parallel processing of quantum computing tasks can be realized in the upper logic layer, and the reliance on the bottom hardware layer is reduced as much as possible.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure, in which:

FIG. 1(a) is a schematic diagram of a quantum computing device according to an embodiment of the present disclosure.

FIG. 1(b) is a schematic flowchart of a method for processing quantum computing tasks according to an embodiment of the present disclosure.

FIG. 2 is a schematic diagram of a method for processing quantum computing tasks according to another embodiment of the present disclosure.

FIG. 3 is a schematic diagram of a visual operation interface according to an embodiment of the present disclosure.

FIG. 4 is a schematic flowchart of a method for processing quantum computing tasks according to another embodiment of the present disclosure.

FIG. 5 is a schematic diagram of a method for processing quantum computing tasks according to another embodiment of the present disclosure.

FIG. 6(a) is a schematic diagram of each stage of processing a quantum computing task according to another embodiment of the present disclosure.

FIG. 6(b) is an overall schematic flowchart of a method for processing quantum computing tasks according to another embodiment of the present disclosure.

FIG. 7 is a structural diagram of an apparatus for processing quantum computing tasks according to an embodiment of the present disclosure.

FIG. 8 is a structural diagram of an apparatus for processing quantum computing tasks according to another embodiment of the present disclosure.

FIG. 9 is a block diagram of an electronic device for implementing a method for processing quantum computing tasks according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope and spirit of the present disclosure. Likewise, for clarity and conciseness, descriptions of well-known functions and structures are omitted in the following descriptions.

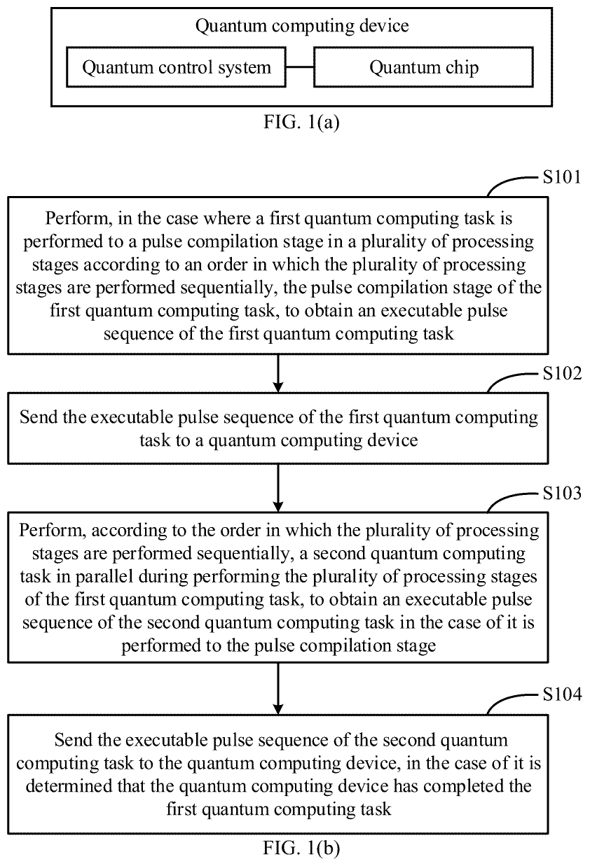

A quantum computing device according to an embodiment of the present disclosure is shown in FIG. 1(a), including a quantum chip and a quantum control system. The quantum chip is integrated with a plurality of quantum bits, wherein each quantum bit is a two-level energy system and has parameters such as transition frequency and transition energy. The parameters need to be regulated by applying corresponding regulation signals (analog signals). The quantum control system may be a room temperature control device for manipulating and measuring the quantum chip.

For a quantum computing task, a series of complex processing can be performed on the quantum computing task by a classical computing device (not shown in FIG. 1(a)) to obtain a pulse sequence executable by the quantum control system, so that the pulse sequence can be sent to the quantum control system by which the quantum chip is controlled to perform the quantum computing.

Since the construction of the quantum computing device relies on complex experimental equipment, the experimental equipment inevitably requires the computational power of the classical computing device. Due to limitations of the computational power of the classical computing device and the network communication speed, time consumed by the classical computing device usually occupies most of the time in the quantum computing task, so that the quantum computing device needs to wait for a computing result of the classical computing device. The quantum chip has much idle time, which greatly reduces the utilization rate of the quantum computing device.

In view of this, an embodiment of the present disclosure provides a method for processing quantum computing tasks for the purpose of increasing the utilization rate of a quantum computing device and increasing the processing efficiency of the quantum computing task. In the method, a parallel pipeline mode is adopted to divide the quantum computing task into a plurality of independent processing stages and parallel processing of different quantum computing tasks is realized at an upper logic layer, so that waiting time of quantum computing device is reduced.

Hereinafter, a scheme proposed by the embodiment of the present disclosure will be discussed with reference to the accompanying figures by taking a first quantum computing task and a second quantum computing task as an example. In the embodiment of the present disclosure, each of the first quantum computing task and the second quantum computing task is divided into a plurality of processing stages based on a parallel pipeline mode. As shown in FIG. 1(b), the method for processing the quantum computing task includes:

S101, performing, in the case where a first quantum computing task is performed to a pulse compilation stage in a plurality of processing stages according to an order in which the plurality of processing stages are performed sequentially, the pulse compilation stage of the first quantum computing task, to obtain an executable pulse sequence of the first quantum computing task.

S102, sending the executable pulse sequence of the first quantum computing task to a quantum computing device.

S103, performing, according to the order in which the plurality of processing stages are performed sequentially, the second quantum computing task in parallel during performing the plurality of processing stages of the first quantum computing task, to obtain an executable pulse sequence of the second quantum computing task in the case of it is performed to the pulse compilation stage.

It should be appreciated that the first quantum computing task and the second quantum computing task have the same processing stages for independent processing, and the order in which the processing stages are performed is the same for the different quantum computing tasks.

S104, sending the executable pulse sequence of the second quantum computing task to the quantum computing device, in the case of it is determined that the quantum computing device has completed the first quantum computing task.

In the embodiment of the disclosure, the parallel pipeline mode is adopted to divide the quantum computing task into independent processing stages, so that low coupling is realized among the processing stages and parallel processing of different quantum computing tasks can be realized. The parallel processing of different quantum computing tasks can improve the processing efficiency of classical computing device on the quantum computing tasks and reduce the overall processing time consumption of the quantum computing tasks. The parallel processing of different quantum computing tasks enables the compiling process of the pulse sequence and the process of sending the executable pulse sequence to the quantum computing device to be executed in parallel and allows the duration of the quantum computing device for waiting for the pulse sequence to be directly and effectively reduced, thereby remarkably improving the utilization rate of the quantum computing device. In addition, in the case of it is determined that the quantum computing device has completed the first quantum computing task, the executable pulse sequence of the second quantum computing task is sent to the quantum computing device according to embodiment of the disclosure. In such a manner, the pulse sequences of different quantum computing tasks can be sequentially sent to the quantum computing device, so that the quantum computing device can sequentially execute the pulse sequences of the different quantum computing tasks. As such, the parallel processing of the quantum computing tasks can be favorably realized at the upper logic layer to reduce reliance on a bottom hardware layer (namely, the quantum computing device) as much as possible, such that the method for processing the quantum computing task according to the embodiment of the disclosure has universality and can be compatible with different quantum computing devices.

In some embodiments, the first quantum computing task is compiled by taking a full amount of bit resources in the quantum computing device as an available resource of the first quantum computing task, to obtain the executable pulse sequence of the first quantum computing task. Therefore, the quantum computing task can be compiled in the compiling stage without considering the idle condition of quantum bits in the quantum computing device, advantageously realizing the task parallelization processing at the upper logic layer and reducing the reliance on hardware equipment.

In some embodiments, a processing stage being performed for the second quantum computing task precedes a processing stage being performed for the first quantum computing task at a same moment.

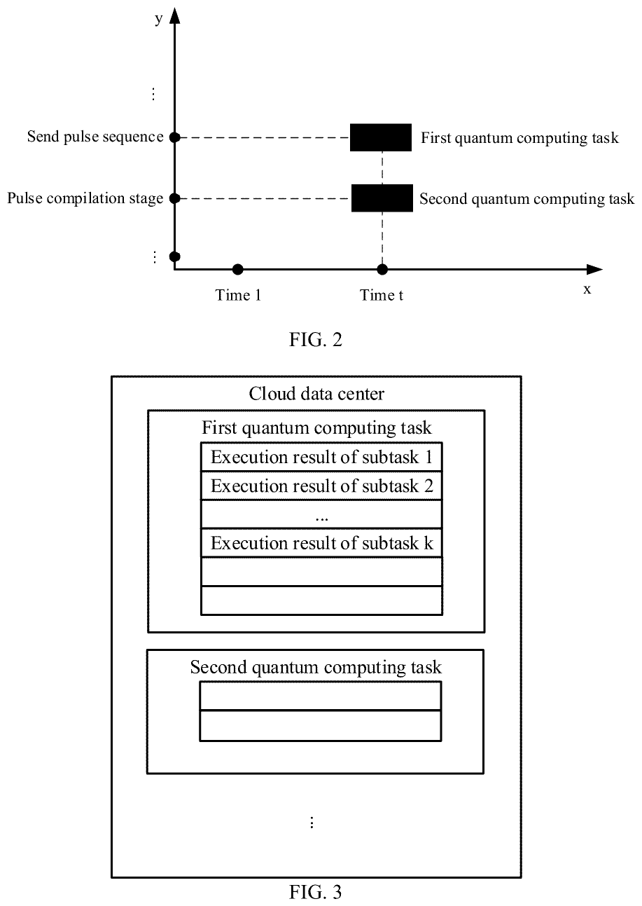

To facilitate understanding of the solution according to the embodiment of the present disclosure, explanation will be provided in conjunction with FIG. 2. As shown in FIG. 2, the x-axis direction represents a time scale and the y-axis direction includes a plurality of processing stages. At time t, the first quantum computing task is already sending the executable pulse sequence, while the second quantum computing task is compiling the executable pulse sequence. It follows that the different tasks are executed simultaneously. By analogy, when the processing stages are added, different quantum computing tasks may be simultaneously processed in different processing stages at time t, thereby realizing that n quantum computing tasks simultaneously run in n processing stages, and thus improving the processing efficiency of the quantum computing tasks.

In the embodiment of the disclosure, execution time of the quantum computing task can be saved and independence between different stages is enhanced by performing different stages of the quantum computing task at the same moment, so that the characteristics of low coupling and high cohesion are realized in multiple processing stages. Therefore, the classical computing efficiency of the quantum computing task is improved, so that the waiting time of the quantum computing device is reduced and the utilization rate of the quantum computing device is improved.

In some embodiments, since the multiple processing stages are needed to be performed in parallel, each of the processing stages is executed using an independent thread.

In the embodiment of the disclosure, the running of each processing stage using the independent thread is beneficial to independent running of multiple processing stages and reduce the coupling degrees of different processing stages, thereby improving the classical computing efficiency of quantum computing tasks, so as to reduce waiting time of quantum computing device and improve utilization rate of the quantum computing device.

It should be noted that, in addition to running each processing stage using the independent thread, each processing stage may be implemented by using an independent circuit module as long as it is ensured that different processing stages run independently, which is not limited in the embodiment of the present disclosure.

In some embodiments, in addition to the pulse compilation stage as set forth above, the processing stages in the parallel pipeline mode further include at least one of.
a task obtaining stage, operable for obtaining a quantum computing task;
a communication phase, operable for communicating with a quantum computing device;
a post-processing stage, operable for performing a post-processing operation on a quantum computing result to obtain an execution result of the quantum computing task; or
a transmission stage, operable for transmitting the execution result of the quantum computing task to a cloud data center.

In some embodiments, a quantum computing task is divided into a plurality of processing stages, where the processing stages include a task obtaining stage, a pulse compilation stage, a communication stage, a post-processing stage, and a transmission stage. Each of the stages can run independently to form a pipeline, so that the utilization rate of the quantum computing device is improved.

In some embodiments, obtaining the quantum computing task may take a certain amount of time. Especially when the quantum computing task is obtained by communicating with the cloud data center, the time to obtain the quantum computing task may increase. In the embodiment of the disclosure, the task obtaining stage is divided out separately as an independent stage. The time length of the quantum computing device waiting for downloading the quantum computing task can be reduced, and therefore the utilization rate of the quantum computing device is improved.

In some embodiments, the communication with the quantum computing device may also take a certain amount of time. The communication stage is divided out separately as an independent stage. The time for transmitting the quantum computing task can be effectively utilized to perform operations of other processing stages, so that the waste caused by the time waiting of the quantum computing device is reduced and the utilization rate of the quantum computing device is improved.

In some embodiments, to efficiently utilize the time for post-processing the quantum computing result, the post-processing stage is divided out separately as an independent stage. The time of the quantum computing task to perform the post-processing can be effectively utilized to perform operations of other processing stages, so that the utilization rate of the quantum computing device is improved.

In some embodiments, the transmission stage is divided out separately to reduce the time consumed by the quantum computing device waiting for the transmission stage. The transmission stage is allowed to be processed along with other stages in parallel, so that the utilization rate of the quantum computing device is improved.

It should be noted that the division of the processing stages is only an example, and in some embodiments, the quantum computing task may be divided into a task obtaining stage, a pulse compilation stage, a communication stage, and an execution result processing stage. The task obtaining stage, the pulse compilation stage and the communication stage have the same functions as those described above, and the execution result processing stage can realize the operations of the post-processing stage and the transmission stage. Of course, the division manner of the quantum computing task is not limited in the embodiment of the present disclosure, and the division can be made based on actual quantum computing tasks.

For ease of understanding, the processing stages will be described below by taking an example where processing stages include a task obtaining stage, a pulse compilation stage, a communication stage, a post-processing stage, and a transmission stage. In the following, the processing stages will be described by taking the first quantum computing task as an example. It can be understood that the execution process of each quantum computing task is the same as that of the first quantum computing task.

### 1) Task Obtaining Stage

In some embodiments, in the case where the processing stages include the task obtaining stage, performing the task obtaining stage of the first quantum computing task can be implemented as follows:

Step A1, obtaining the first quantum computing task from a cloud data center.

Herein, the cloud data center may be a SaaS (Soft As A Service) data center or may also be other cloud servers, which is not limited in this disclosure.

In some embodiments, task data of the first quantum computing task includes data information such as a pulse gate parameter, a measurement and control parameter, and the like.

In the embodiment of the present disclosure, in order to facilitate the management of the quantum computing task, a task manager can be provided. Accordingly, in Step A2, a request for storing the first quantum computing task to a storage space of quantum computing task is sent to a task manager.

Herein, the storage space for storing the quantum computing task may be in the form of a task queue or the quantum computing task may be stored in other manners, which is not limited in the embodiment of the present disclosure.

Step A3, receiving response information of the task manager to the request.

Herein, the first quantum computing task may be subjected to validity check because the task may fail due to the quantum computing task being invalid, and the post-processing is performed on the first quantum computing task when the check is passed.

Herein, the validity check can include checking whether parameter definitions of quantum computing tasks are contradictory and whether a format of each data conforms to an expected definition, for example. Of course, the validity check may be set based on a specific task, which is not limited in the embodiment of the present disclosure.

Step A4, sending, in the case where the response information indicates that the first quantum computing task is allowed to be stored, the first quantum computing task to the task manager to store the first quantum computing task in the storage space of quantum computing task.

In an implementation, when the task manager is responsible for performing validity check on the first quantum computing task, the task manager may feed back response information indicating that the storage space of quantum computing task allows the first quantum computing task to be stored, in the case of it is determined that the first quantum computing task is valid and the storage space of quantum computing task is sufficient.

In the case of executing multiple quantum computing tasks, an execution order of the quantum computing tasks may be determined based on priorities of the tasks, and an ordering of the quantum computing tasks in the storage space of quantum computing task may be determined based on the execution order.

The quantum computing tasks can be stored in the storage space of quantum computing task in a queue-based mode, and therefore the execution order of the quantum computing tasks can be determined based on the first-in first-out principle of the queue.

In some embodiments, the first quantum computing task is fetched from the SaaS data center as an example. Upon obtaining the first quantum computing task from the SaaS data center, the task manager performs the validity check on the received first quantum computing task. Response information of analysis failure is returned in the case where a check result is illegal; the storage space of quantum computing task is detected in the case where the check result is legal, and response information of busyness is returned in the case where a task number of the quantum computing tasks in the storage space is more than or equal to a set threshold (i.e., the storage space of quantum computing task is insufficient); in the case where the task number is smaller than the set threshold, it can be determined that the storage space of quantum computing task is sufficient, and the first quantum computing task is stored in the storage space of quantum computing task.

In the embodiment of the disclosure, the task is obtained based on a cloud data center, and multiple users of the cloud data center can issue the task at the same time. This stage is divided out as an independent stage to reduce a time interval of executing the downloading operation between different quantum computing tasks and reduce waiting time of the quantum computing device, thereby improving the utilization rate of the quantum computing device.

In some embodiments, different quantum computing tasks issued by different users may be combined into a first quantum computing task, and then the first quantum computing task is processed based on a parallel pipeline mode.

In some embodiments, in the case of excessive quantum computing tasks, a plurality of sub-threads executing in parallel may be enabled in the task obtaining stage, each sub-thread is used to download one quantum computing task, and then a plurality of quantum computing tasks may be obtained from the cloud data center at the task obtaining stage at the same time. Therefore, the waiting time of the quantum computing device is reduced, and the utilization rate of the quantum computing device is improved.

In addition, the quantum computing task is obtained from the cloud data center. The time during which the quantum computing task is obtained is utilized in conjunction with the parallel pipeline mode in the embodiment of the disclosure to perform other processing stages, so that the parallel processing of different quantum computing tasks is realized and the utilization rate of the quantum computing device is improved.

### 2) Pulse Compilation Stage

In some embodiments, compiling the first quantum computing task in the pulse compilation stage to obtain the executable pulse sequence of the first quantum computing task can be implemented as follows: obtaining the first quantum computing task from the storage space of quantum computing task; compiling the first quantum computing task into an original pulse sequence; compiling the original pulse sequence into an executable pulse sequence which can be identified a quantum computing device, based on an execution requirement of the quantum computing device.

In the case where the first quantum computing task includes a plurality of subtasks, the subtasks in the first quantum computing task are compiled to obtain an executable pulse sequence of the subtasks, which can be implemented as follows:

Step B1, obtaining the first quantum computing task from the storage space of quantum computing task.

Not limited to the method of storing the quantum computing task in the storage space of quantum computing task in the task obtaining stage as described above, any method capable of storing the quantum computing task in the storage space of quantum computing task is applicable to the embodiment of the disclosure. For example, in the pulse compilation stage, the task can be obtained and stored in the storage space of quantum computing task.

Step B2, dividing the first quantum computing task into a plurality of subtasks.

Herein, the first quantum computing task can be divided into the plurality of subtasks based on complexity of the first quantum computing task or other situations, which is not limited in the embodiment of the disclosure.

Step B3, compiling each of the subtasks to obtain an original pulse sequence of each subtask.

Herein, the original pulse sequence refers to a pulse sequence that is not further processed according to the execution requirement of the quantum computing device. The original pulse sequence consists of several sets of pulse waveform function F (t, \vec{α}) and pulse parameters \vec{α}={ω, ω_{AWG}, ϕ, μ, T₀, T, \vec{β}}, where t represents time, ω represents target frequency, ω_{AWG} represents arbitrary wave generator (AWG) frequency, ϕ represents phase, μ represents amplitude scaling factor, T₀ represents start time, T represents pulse duration, \vec{β} represents other parameters required by the pulse waveform function (different parameters are assigned according to different pulse waveform functions). All mathematical quantities contained in the pulse parameters \vec{α} can be referenced using a measurement and control parameter management module. The measurement and control parameter management module can provide a user operation interface. A user can directly reuse parameters in a created task or existing parameters to realize the reference of parameters.

Step B4, compiling the original pulse sequence of each subtask into the executable pulse sequence which can be recognized by the quantum computing device, based on an execution requirement of the quantum computing device.

Herein, since some data information in the original pulse sequence needs to be adjusted; for example, information such as time, intensity, etc. may need to be adjusted to be recognized by the quantum computing device. In view of this, the execution requirement of the quantum computing device may be understood as a requirement specified according to a preset format, and the requirement specified by the preset format may be set based on the properties and requirements of the quantum computing device in actual situations. For example, for superconducting quantum hardware, it is usually necessary to compile the original pulse sequence defined by functions and parameters into a Piece-Wise Constant (PWC) waveform arranged at equal intervals in time so that the AWG generates a control signal.

Step B5, storing the executable pulse sequence of each subtask in a storage space of pulse.

In some embodiments, storing the executable pulse sequence of each subtask in the storage space of the pulse can be implemented as follows: for each subtask of the first quantum computing task, determining a sequence identifier of the executable pulse sequence of the subtask based on a task identifier of the first quantum computing task and a subtask identifier of the subtask; and storing the executable pulse sequence of the subtask and the corresponding sequence identifier in the storage space of the pulse controlled by a pulse sequence manager.

For example, if the task identifier of the first quantum computing task is A and a subtask identifier of the first subtask of the first quantum computing task is A₁, then a sequence identifier of the executable pulse sequence of the first subtask of the first quantum computing task is AA₁. It follows that the storage space of the pulse stores the subtask in the form of: sequence identifier (including task identifier and subtask identifier)—executable pulse sequence.

In the embodiment of the disclosure, the executable pulse sequence and the sequence identifier are correspondingly stored in the storage space of the pulse, which is beneficial to obtaining the executable pulse sequence of the same quantum computing task based on the sequence identifier in the subsequent operation, and which provides a data basis for accelerating the processing of the quantum computing task.

In some embodiments, since there may be many subtasks in the first quantum computing task, multiple threads executing in parallel may be enabled in this stage, each thread being used to compile a single subtask. Since the subtasks have an execution order, the execution order of the executable pulse sequence of the subtasks in the storage space of the pulse can be determined based on the execution order of the subtasks.

For example, the task identifier of the first quantum computing task is A, the subtask identifier of the first subtask of the first quantum computing task is A₁, and the subtask identifier of the second subtask of the first quantum computing task is A₂. The first subtask is completed before the second subtask. In the case where the executable pulse sequence of the first subtask is generated before the executable pulse sequence of the second subtask, the executable pulse sequence corresponding to each subtask may be stored in the storage space of the pulse based on the execution order. In the case where the executable pulse sequence of the first subtask is generated after the executable pulse sequence of the second subtask, the executable pulse sequence of the first subtask and the executable pulse sequence of the second subtask may be stored in the storage space of pulse in an order in which the first subtask is executed first and the second subtask is executed later.

In the embodiment of the disclosure, by dividing the quantum computing task into different subtasks, the executable pulse sequences of different subtasks can be obtained as soon as possible, so that the processing efficiency of the first quantum computing task is improved, the time for the quantum computing device to wait for the executable pulse sequences is reduced, and the utilization rate of the quantum computing device is improved.

It should be noted that each quantum computing task is compiled into one or more tuples composed of the original pulse sequence and the measurement and control parameter set, and the one or more tuples are stored in the storage space of the pulse. Each tuple identifier is represented by a sequence identifier or task identifier of a quantum computing task. The corresponding quantum computing task and the executable pulse sequence corresponding to the quantum computing task can be obtained based on the sequence identifier or the task identifier in the tuple identifier in the subsequent task obtaining.

### 3) Communication Stage

In some embodiments, in the case where the processing stages include the communication stage, performing the communication stage of the first quantum computing task can be implemented as follows: sending the executable pulse sequence of the first quantum computing task to the quantum computing device; and receiving a quantum computing result of the first quantum computing task sent by the quantum computing device.

Herein, the executable pulse sequence of the first quantum computing task is obtainable from the storage space of the pulse. A location of the executable pulse sequence of the first quantum computing task in the storage space of pulse can be determined based on the tuple identifier corresponding to the first quantum computing task.

In the embodiment of the disclosure, this stage is processed in parallel with other stages, so that the time for sending the executable pulse sequence and receiving the quantum computing result is effectively complexed and the utilization rate of the quantum computing device is improved.

In some embodiments, determining whether the quantum computing device has completed the first quantum computing task can be implemented as follows: upon receiving the quantum computing result of the first quantum computing task, determining that the quantum computing device has completed the first quantum computing task.

In the embodiment of the disclosure, execution progress of the quantum computing device on the first quantum computing task is determined based on a receiving condition of the quantum computing result of the first quantum computing task, to timely send an executable pulse sequence of the next task to the quantum computing device, so that the sequential execution of the tasks is effectively ensured while the utilization rate of the quantum computing device is improved.

It should be noted that, in the communication stage, upon receipt of the quantum computing result of the previous executable pulse sequence, the executable pulse sequence of the next task is sent to the quantum computing device for the quantum computing.

In some embodiments, in the communication stage, the quantum computing result of the first quantum computing task can also be stored in a storage space of quantum computing result.

In the embodiment of the disclosure, the quantum computing result of the first quantum computing task is stored in the storage space of quantum computing result, so that the quantum computing result is obtained from the storage space of quantum computing result and processed in subsequent stages without affecting operations in other stages, thereby improving the utilization rate of the quantum computing device.

In some embodiments, to facilitate the obtaining of the quantum computing result from the storage space of quantum computing result and the processing in subsequent stages, the storage space of quantum computing result can be controlled by a pulse manager.

In the embodiment of the disclosure, the pulse manager is adopted to manage the storage space of quantum computing result, so that it is convenient for an independent pulse manager to execute a management strategy and to provide technical support for adapting to the management requirements of increasingly complex quantum computing tasks.

In some embodiments, sending the executable pulse sequence of the first quantum computing task to the quantum computing device in the communication stage can be further implemented as follows: in the case where the first quantum computing task includes a plurality of subtasks, sending executable pulse sequences of the subtasks to the quantum computing device one by one, wherein in the case of it is determined that the quantum computing device has completed a previous subtask, a next subtask is sent to the quantum computing device.

In an implementation, the executable pulse sequences of the subtasks can be sequentially sent to the quantum computing device based on the execution order of the subtasks. For example, the first subtask is performed before the second subtask, and upon receipt of the quantum computing result of the first subtask, the executable pulse sequence of the second subtask is sent to the quantum computing device for the quantum computing.

In the embodiment of the disclosure, the subtasks in the first quantum computing task are performed sequentially, so as to ensure sequential execution of the same quantum computing task and accuracy of an execution result.

### 4) Post-Processing Stage

In some embodiments, in the case where the processing stages include a post-processing stage, performing the post-processing stage of the first quantum computing task can be implemented as follows:

Step C1, performing the post-processing operation on the quantum computing result of the first quantum computing task to obtain the execution result of the first quantum computing task.

Herein, the post-processing operation can be set based on the actual situation of the classic computing device, which is not limited in the embodiment of the disclosure. The post-processing operation can be to analyze and process the quantum computing result according to a user requirement to obtain the execution result of the first quantum computing task.

Step C2, storing the execution result of the first quantum computing task and the corresponding task identifier in a storage space of execution result.

In the embodiment of the disclosure, the execution result of the quantum computing task can be accurately identified based on the task identifier to provide a data basis for subsequent processing. In addition, the post-processing stage is parallel to other processing stages, so that the time of other processing stages can be effectively multiplexed to obtain the executable result of the quantum computing task as soon as possible and the utilization rate of the quantum computing device is improved.

In some embodiments, to facilitate the subsequent obtaining and processing of the execution result from the storage space of execution result, the storage space of execution result can be controlled by the task manager.

In the embodiment of the disclosure, the task manager is adopted to manage the storage space of execution result, so that it is convenient for the independent task manager to execute the management strategy to provide technical support for adapting to the management requirement of increasingly complex quantum computing tasks.

### 5) Transmission Stage

In some embodiments, a quantum computing task may have a plurality of subtasks, each subtask corresponds to a respective executable pulse sequence, and each executable pulse sequence corresponds to an execution result.

In the case where the processing stages include a transmission stage, performing the transmission stage of the first quantum computing task can be implemented as follows:

Step D1, obtaining the execution result of the subtask in the first quantum computing task from the storage space of execution result.

In some embodiments, the execution result of the subtask in the first quantum computing task is obtained from the storage space of execution result in the case where any one of the following sending conditions is met:

Condition 1: the number of execution results of the subtasks of the first quantum computing task in the storage space of execution result is greater than a number threshold.

Some quantum computing tasks may have a great number of the executable pulse sequences. For example, if the first quantum computing task generates 1000 executable pulse sequences, a threshold may be set for the executable pulse sequences, and assuming that the threshold is set to 20, the execution result of the first quantum computing task may be uploaded once every 20 subtasks are performed. Certainly, after the execution result of the 20 subtasks is uploaded, the execution result can be deleted in the storage space of execution result. In such a manner, a user is allowed to know the execution progress of the quantum computing task in time through the cloud data center.

It should be noted that the number threshold may be set based on actual situations, which is not limited in the embodiment of the disclosure.

In the embodiment of the disclosure, whether to obtain the execution result of the subtasks in the first quantum computing task is determined based on the number threshold of the execution result in the storage space of execution result, so that the execution result can be uploaded in time to allow the user to know the execution progress of the quantum computing task.

Condition 2: a time interval from the last sending of the execution result of the first quantum computing task to the cloud data center is greater than a time threshold.

Some quantum computing tasks may have a long execution time for each executable pulse sequence. For example, it may take t1 to obtain an execution result of a first executable pulse sequence in a first quantum computing task, and it may take t2 to obtain an execution result of a second executable pulse sequence in the first quantum computing task, where t2>t1. The time threshold may be set to t3, where t3>t2. In the case where no new execution result is uploaded for a time period over t3, the execution result within the time period is uploaded to the cloud data center. In the meanwhile, the execution result which has been successfully uploaded in the time period is deleted in the storage space of execution result. In such a manner, the operator is allowed to check the execution progress of the quantum computing task in time.

In the embodiment of the disclosure, whether to obtain the execution result of the subtasks in the first quantum computing task is determined based on the time threshold, so that the execution result can be uploaded in time while allowing the user to know the execution progress.

Step D2, transmitting the execution result of the subtask of the first quantum computing task to the cloud data center.

In the embodiment of the disclosure, the execution result of each subtask in the quantum computing task can be uploaded in real time based on the cloud data center. In such a manner, multiple users are allowed to check the result of the quantum computing task through the cloud data center at the same time and to know the execution progress of the task.

In the case where the quantum computing task includes a plurality of subtasks, for example, the first subtask is performed before the second subtask. Under the condition of obtaining the execution result of the first subtask, the execution result is uploaded to the cloud data center in time, and in the meanwhile the post-processing performed on the second subtask, so that the user can know that the first subtask has been completed and the second subtask is currently being performed.

Herein, the cloud data center can be communicated with a visual operation interface, which is shown in FIG. 3. Each quantum computing task has a plurality of subtasks, each subtask corresponds to one executable pulse sequence, and one executable pulse sequence corresponds to one execution result. As shown in FIG. 3, when the k-th subtask in the first quantum computing task is completed, the execution result of the k-th subtask is displayed in the interface, so that the user is allowed to check the execution progress of each quantum computing task in time.

In some embodiments, performing the transmission stage of the first quantum computing task can be further implemented as follows: in the case of detecting that the execution of the first quantum computing task is abnormal or in the case of it is determined that all the execution results of the first quantum computing task are sent to the cloud data center, sending a notification message to the cloud data center.

In order to allow the user to know the execution progress of the quantum computing task in time, when the last execution result belonging to the first quantum computing task is uploaded, prompt information that the first quantum computing task is completed can be uploaded at the same time; when an abnormality such as task interruption occurs in the execution process of the first quantum computing task, the quantum computing task needs to be immediately terminated and prompt information is sent to the cloud data center.

In the embodiment of the disclosure, the task execution condition is fed back to the cloud data center in time, so that the user is allowed to check the quantum computing task execution condition in time.

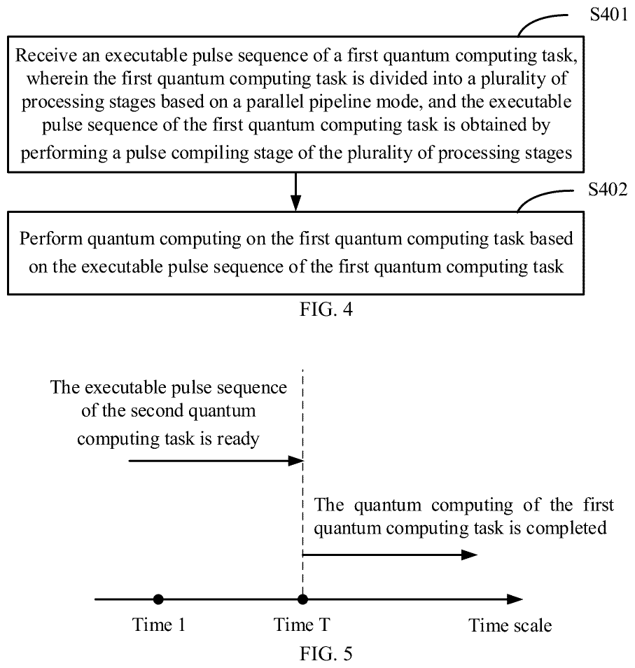

Based on the same technical concept, an embodiment of the present disclosure also provides a method for processing quantum computing tasks, which is applied to a quantum computing device and which can be implemented as shown in FIG. 4, including:

S401, receiving an executable pulse sequence of a first quantum computing task, wherein the first quantum computing task is divided into a plurality of processing stages based on a parallel pipeline mode, and the executable pulse sequence of the first quantum computing task is obtained by performing a pulse compiling stage of the plurality of processing stages; and

S402, performing quantum computing on the first quantum computing task based on the executable pulse sequence of the first quantum computing task.

Herein, the method of processing the first quantum computing task by a classical computing device to obtain the executable pulse sequence can reference to the description as set forth above, and will not be described once more.

In the embodiment of the disclosure, the quantum computing task is divided into the plurality of low-coupling independent processing stages based on the parallel pipeline mode, so as to reduce the waiting time of the quantum computing device, thereby improving the utilization rate of the quantum computing device.

In some embodiments, as can be seen from the foregoing processing manner of the parallel pipeline mode for the quantum computing task, in the process of performing the quantum computing based on the executable pulse sequence of the first quantum computing task, compilation of an executable pulse sequence of a second quantum computing task has been completed based on the plurality of processing stages of the parallel pipeline mode. Therefore, according to the embodiment of the present disclosure, the executable pulse sequence of the second quantum computing task is received in the case where the executing of the executable pulse sequence of the first quantum computing task is completed; and quantum computing is performed based on the executable pulse sequence of the second quantum computing task.

In some embodiments, as shown in FIG. 5, the lateral direction represents a time scale, and the first quantum computing task is performed before the second quantum computing task. At time T, the quantum computing of the first quantum computing task is completed and the executable pulse sequence of the second quantum computing task is ready.

In the embodiment of the disclosure, upon the completion of the quantum computing of the first quantum computing task, the executable pulse sequence of the second quantum computing task is ready, so that the waiting time between the two tasks is reduced and the utilization rate of the quantum computing device is improved.

In some embodiments, the processing stages include, in addition to the pulse compilation stage, at least one of:
a task obtaining stage, operable for obtaining a quantum computing task;
a communication phase, operable for communicating with a quantum computing device;
a post-processing stage, operable for performing a post-processing operation on a quantum computing result to obtain an execution result of the quantum computing task; or
a transmission stage, operable for transmitting the execution result of the quantum computing task to a cloud data center.

In some embodiments, a quantum computing task is divided into a plurality of processing stages, where the processing stages include a task obtaining stage, a pulse compilation stage, a communication stage, a post-processing stage, and a transmission stage. Each of the stages can run independently to form a pipeline, so that the utilization rate of the quantum computing device is improved.

In some embodiments, obtaining the quantum computing task may take a certain amount of time. Especially when the quantum computing task is obtained by communicating with the cloud data center, the time to obtain the quantum computing task may increase. In the embodiment of the disclosure, the task obtaining stage is divided out separately as an independent stage. The time length of the quantum computing device waiting for downloading the quantum computing task can be reduced, and therefore the utilization rate of the quantum computing device is improved.

In some embodiments, the communication with the quantum computing device may also take a certain amount of time. The communication stage is divided out separately as an independent stage. The time for transmitting the quantum computing task can be effectively utilized to perform operations of other processing stages, so that the waste caused by the time waiting of the quantum computing device is reduced and the utilization rate of the quantum computing device is improved.

In some embodiments, to efficiently utilize the time for post-processing the quantum computing result, the post-processing stage is divided out separately to be performed along with other stages in parallel, so that the utilization rate of the quantum computing device is improved.

In some embodiments, the transmission stage is divided out separately to reduce the time consumed by the quantum computing device waiting for the transmission stage. The transmission stage is allowed to be processed along with other stages in parallel, so that the utilization rate of the quantum computing device is improved.

It should be noted that the division of the processing stages is only an example, and in some embodiments, the quantum computing task may be divided into a task obtaining stage, a pulse compilation stage, a communication stage, and an execution result processing stage. The task obtaining stage, the pulse compilation stage and the communication stage have the same functions as those described above, and the execution result processing stage can realize the operations of the post-processing stage and the transmission stage. Of course, the division manner of the quantum computing task is not limited in the embodiment of the present disclosure, and the division can be made based on actual quantum computing tasks.

In the embodiment of the present disclosure, the processing stages can be implemented by respective processing units. Each of the processing units can be implemented as an electronic device or a process. The parallel processing efficiency of the quantum computing tasks can be improved by adding sub-processes in the process of the processing unit.

In addition to the processing stages, the embodiment of the present disclosure can further include two managers, which are a task manager and a pulse manager, respectively, in which:

A storage space manageable by the task manager includes: 1) a storage space for quantum computing tasks, 2) a storage space for execution results;

A storage space manageable by the pulse manager includes: 1) a storage space for pulses, 2) a storage space for quantum computing results.

Based on the management of the two managers on the storage spaces, Access to corresponding data in the storage spaces can be conveniently realized by accessing to the managers, and compared with accesses to the processing stages, the number of interfaces to be accessed can be reduced.

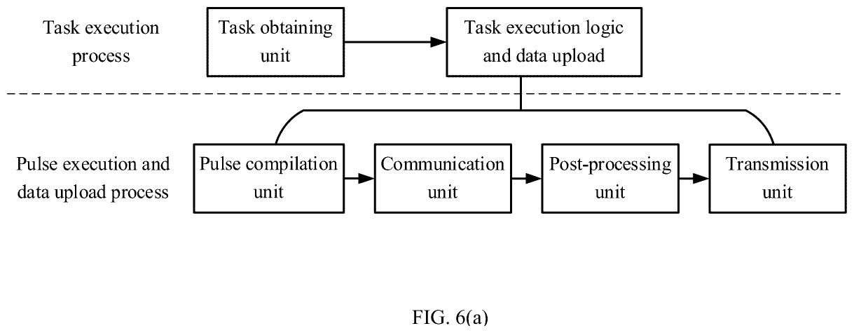

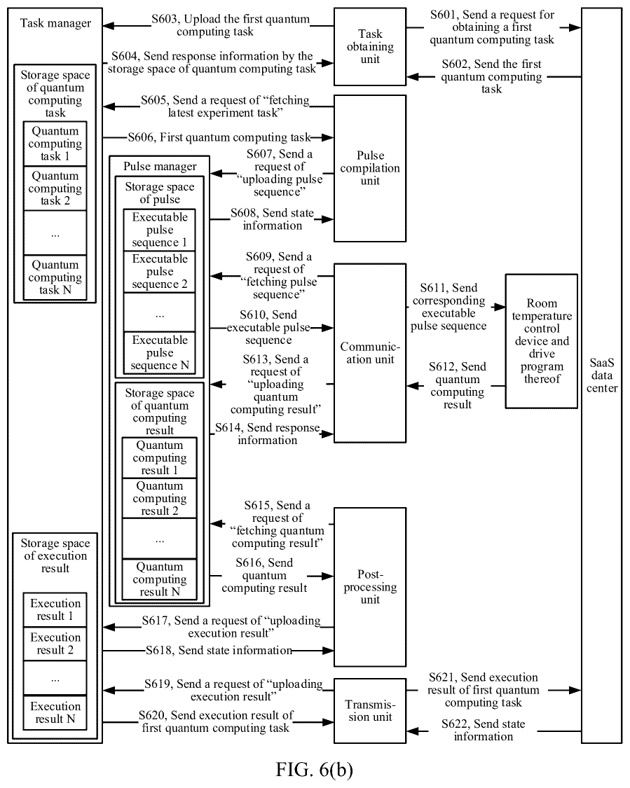

Depending on the units of the above-defined processing stages, as shown in FIG. 6(a), the quantum computing task can be divided into two processes, which are a task execution process and a pulse execution and data uploading process, in which:

In the task execution process, the task obtaining unit is responsible for downloading quantum computing tasks submitted by users from a SaaS data center, and the tasks are stored in the storage space of quantum computing task in the task manager.

In the pulse execution and data uploading process, the pulse compilation unit fetches tasks from the storage space, compiles the tasks into one or more pulse sequences, and uploads the pulse sequences to the storage space of the pulse in the pulse manager to form a pulse queue. The pulse sequences are fetched one by one by the communication unit, and the communication unit is responsible for transmitting to a room temperature control device (or a driver), sending a control instruction, and receiving a measurement result (i.e., a quantum computing result).

As can be seen, each pulse sequence corresponds to a set of measurement results, which are uploaded to the storage space of quantum computing result in the pulse manager, waiting for the post-processing unit to fetch and process the measurement results to obtain a final execution result. Subsequently, the post-processing unit uploads the execution result to the storage space of execution result in the task queue manager. Finally, the transmission unit fetches the execution result to be uploaded and uploads it to the SaaS data center.

Parallel processing is embodied by processing different quantum computing tasks, and the execution order of the first quantum computing Task (Task 0), the second quantum computing Task (Task 1), the third quantum computing Task (Task 2), the fourth quantum computing Task (Task 3) and the fifth quantum computing Task (Task 4) in time is explained. As shown in Table 1, at time T₁, Task 0 performs the task execution process, at time T₂, Task 0 performs the pulse execution and data upload process, and the next Task 1 performs the task execution process, and so on until all tasks are completed.

TABLE 1

| Time | Task obtaining unit | Task execution logic and data upload |
|---|---|---|
| T₁ | Task 0 | — |
| T₂ | Task 1 | Task 0 |
| T₃ | Task 2 | Task 1 |
| T₄ | Task 3 | Task 2 |
| T₅ | Task 4 | Task 3 |

The Pulse execution and data upload process can be further divided into a pulse compilation unit, a communication unit, a post-processing unit and a transmission unit, and is described by the execution order of the first quantum computing Task (Task 0) and the second quantum computing Task (Task 1) in time, as shown in Table 2, where the first quantum computing Task includes a first subtask (Task 0, Pulse 0), a second subtask (Task 0, Pulse 1) and a third subtask (Task 0, Pulse 2). The second quantum computing task includes a first subtask (Task 1, Pulse 0) and a second subtask (Task 1, Pulse 1).

At time T₁′, Task 0, Pulse 0 performs the pulse compilation unit.

At time T₂′, Task 0, Pulse 0 performs the communication unit, and the next subtask Task 0, Pulse 1 performs the pulse compilation unit.

At time T₃′, Task 0, Pulse 0 performs the post-processing unit, the next subtask Task 0, Pulse 1 performs the communication unit, and the next subtask Task 0, Pulse 2 performs the pulse compilation unit, and so on until all tasks are completed.

TABLE 2

| | Pulse | Communi- | Post- | |
|---|---|---|---|---|
| | compilation | cation | processing | Transmission |
| Time | unit | unit | unit | unit |
| T₁′ | Task 0, Pulse 0 | — | — | — |
| T₂′ | Task 0, Pulse 1 | Task 0, Pulse 0 | — | — |
| T₃′ | Task 0, Pulse 2 | Task 0, Pulse 1 | Task 0, Pulse 0 | — |
| T₄′ | Task 1, Pulse 0 | Task 0, Pulse 2 | Task 0, Pulse 1 | Task 0, Pulse 0 |
| T₅′ | Task 1, Pulse 1 | Task 1, Pulse 0 | Task 0, Pulse 2 | Task 0, Pulse 1 |

As shown in FIG. 6(b), by treating each processing stage as an independent unit, the task manager manages the quantum computing tasks in the storage space of quantum computing task and the execution results in the storage space of execution result, and manages the executable pulses in the storage space of the pulse and the quantum computing results in the storage space of quantum computing result based on the pulse manager. The processing stages are respectively completed by the task obtaining unit, the pulse compilation unit, the communication unit, the post-processing unit and the transmission unit. The quantum computing device controls the quantum chip by the room temperature control device and the drive program thereof. The processing of the first quantum computing task is illustrated in FIG. 6(b), including:
S601, sending, by the task obtaining unit, a request for obtaining a first quantum computing task to the SaaS data center.

If there are a plurality of quantum computing tasks, the task obtaining unit can obtain the quantum computing tasks from the cloud data center by adopting a plurality of sub-threads.
S602, sending, by the SaaS data center, the first quantum computing task to the task obtaining unit.
S603, requesting, by the task obtaining unit, a task manager to upload the first quantum computing task to a storage space of quantum computing task.

The task obtaining unit fetches the first quantum computing task from the SaaS data center by sending the request to the task manager via a first port.

The task manager monitors the first port in real time, and checks validity of the first quantum computing task in the case where the first port receives the request from the task obtaining unit. Response information is sent to the task obtaining unit based on a check result of the validity of the task and a task number in the storage space of quantum computing task. In the case where the first quantum computing task is valid and the storage space of quantum computing task is sufficient, in S604, the task manager sends response information that the first quantum computing task is allowed to be stored in the storage space of quantum computing task to the task obtaining unit. Thus, the task obtaining unit stores the first quantum computing task in the storage space of quantum computing task.

Of course, in the case where the first quantum computing task is invalid or the storage space is insufficient, the response information can be sent to inform the task obtaining unit that the first quantum computing task is not allowed to be stored in the storage space of quantum computing task. After receiving the response information, the task obtaining unit may reserve (e.g., cache) the first quantum computing task in its own storage space, and retry uploading later. In the case of storing the first quantum computing task to the storage space of quantum computing task, the task obtaining unit deletes the first quantum computing task from its own cache, and then uploads the next quantum computing task to the task manager.

S605, sending, by the pulse compilation unit, a request of “fetching latest experiment task (POP_LATEST_TASK)” to the task manager to obtain the first quantum computing task.

The task manager and the pulse compiling unit are communicated via a second port. In an implementation, the task manager monitors the second port in real time and reads the first quantum computing task from the storage space of quantum computing task in the case where the pulse compilation unit is monitored to send a request of “fetching latest experiment task (POP_LATEST_TASK)”, and in S606, the task manager issues the first quantum computing task to the pulse compilation unit. The pulse compilation unit receives the first quantum computing task through the second port. The pulse compilation unit compiles the first quantum computing task to obtain an executable pulse sequence.

If there is no quantum computing task, the pulse compilation unit can be informed of no executable task. The pulse compilation unit can re-request a task based on a trigger event.

S607, sending, by the pulse compilation unit, a request of “uploading pulse sequence (APPEND_PULSE_SEQ)” to the pulse manager, and uploading the executable pulse sequence of the first quantum computing task in the storage space of pulse.

The pulse manager and the pulse compilation unit are communicated via a third port. The pulse manager monitors the third port in real time, stores the executable pulse sequences corresponding to the first quantum computing tasks that need to be sequentially performed in the storage space of pulse in the case where the third port monitors the request of “uploading pulse sequence (APPEND_PULSE_SEQ)”, and in S608, the pulse manager sends state information as to whether the storage is successful or not to the pulse compilation unit.

S609, sending, by the communication unit, a request of “fetching pulse sequence (POP_LATEST_PULSE_SEQ)” to the pulse manager to obtain the executable pulse sequence.

The communication unit and the pulse manager are communicated in real time via a fourth port. The pulse manager monitors the fourth port in real time. In the case of monitoring the request of “fetching pulse sequence (POP_LATEST_PULSE_SEQ)”, the pulse manager reads the executable pulse sequence from the storage space of pulse.

In the case where the storage space of pulse stores the executable pulse sequence, the executable pulse sequence is read. If the executable pulse sequence of the first quantum computing task needs to be performed currently, in S610, the pulse manager sends the executable pulse sequence to the communication unit via the fourth port.

If there is no executable pulse sequence, the communication unit can be informed of no executable task. The communication unit can re-request a task based on a trigger event.

S611, sending, by the communication unit, the executable pulse sequence to the room temperature control device and the drive program thereof. The room temperature control device generates a control signal for the quantum chip based on the executable pulse sequence and the measurement and control parameter to drive the quantum chip to perform the quantum computing.

S612, receiving, by the communication unit, the quantum computing result from the room temperature control device and the drive program thereof after the quantum computing result is obtained.

S613, sending, by the communication unit, a request of “uploading raw measurement result (APPEND_RAW_MEAS_RES)” to the pulse manager, and uploading the quantum computing result corresponding to the first quantum computing task to the storage space of quantum computing result.

The pulse manager monitors a fifth port in real time, and stores the quantum computing result in the storage space of quantum computing result in the case where the fifth port monitors the request of “uploading raw measurement result (APPEND_RAW_MEAS_RES)”, and in S614, the pulse manager returns response information as to whether the uploading is successful or not to the communication unit.

S615, sending, by the post-processing unit, a request of “fetching raw measurement data (POP_RAW_MEAS_RES)” to the pulse manager, obtaining the quantum computing result of the first quantum computing task, performing quantum post-processing, and obtaining the execution result of the first quantum computing task.

The pulse manager monitors a sixth port in real time, and obtains the quantum computing result of the first quantum computing task from the storage space of quantum computing result in the case where the sixth port monitors the request based on “fetching raw measurement data (POP_RAW_MEAS_RES)”, and in S616, the pulse manager sends the quantum computing result to the post-processing unit. The post-processing unit calls a related data processing program to post-process the quantum computing result to obtain the execution result of the first quantum computing task.

If there is no quantum computing result, the pulse manager can inform the post-processing unit of no executable task. The post-processing unit can re-request a task based on a trigger event.

S617, sending, by the post-processing unit, a request of “uploading experiment result (APPEND_EXP_RESULT)” to the task manager, to upload the execution result of the first quantum computing task in the storage space of execution result.

The task manager monitors a seventh port in real time, and transmits the execution result to the storage space of execution result for storage in the case where the seventh port receives the request of “uploading experiment result (APPEND_EXP_RESULT)”. In S618, the task manager feeds back state information as to whether the execution result is successfully stored to the post-processing unit.

S619, sending, by the transmission unit, a request of “uploading data block (execution result) (POP_LATEST_BLOCK)” to the task manager.

The task manager monitors an eighth port in real time, obtains the execution result of the first quantum computing task from the storage space of execution result in the case the eighth port receives the request of “upload data block (POP_LATEST_BLOCK)”, and in S620, sends the execution result to the transmission unit.

If there is no execution result, the transmission unit can be informed that no execution result is available for uploading. The transmission unit can subsequently re-request a task based on a trigger time.

S621, uploading, by the transmission unit, the execution result of the first quantum computing task to the SaaS data center, and obtaining, in S622, state information as to whether the uploading is successful returned from the SaaS data center.

In the embodiment of the disclosure, the parallel pipeline mode is adopted to divide the processing flow of the quantum computing task into a plurality of independent processing stages to realize the separation of the logic layer from the hardware layer, so that the quantum computing task can be processed by using a more modern and unified standard port. Different units/managers can access the framework of the embodiment of the disclosure only by implementing specific functional ports, thereby realizing stronger universality.

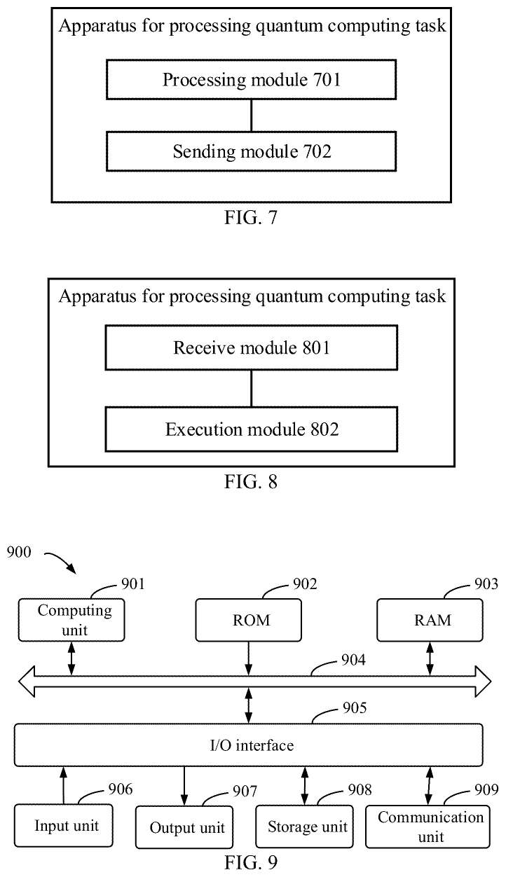

Based on the same technical concept, an embodiment of the present disclosure further provides an apparatus for processing quantum computing tasks, where each of a first quantum computing task and a second quantum computing task is divided into a plurality of processing stages based on a parallel pipeline mode, and as shown in FIG. 7, the apparatus includes:
a processing module 701, configured to perform, in the case where a first quantum computing task is performed to a pulse compilation stage in a plurality of processing stages according to an order in which the plurality of processing stages are performed sequentially, the pulse compilation stage of the first quantum computing task, to obtain an executable pulse sequence of the first quantum computing task;
a sending module 702, configured to send the executable pulse sequence of the first quantum computing task to a quantum computing device.

The processing module 701 is further configured to perform, according to the order in which the plurality of processing stages are performed sequentially, the second quantum computing task in parallel during performing the plurality of processing stages of the first quantum computing task, to obtain an executable pulse sequence of the second quantum computing task in the case of it is performed to the pulse compilation stage; and

The sending module 702 is further configured to send the executable pulse sequence of the second quantum computing task to the quantum computing device in the case of it is determined that the quantum computing device has completed the first quantum computing task.

In some embodiments, the processing module 701 is configured to perform the pulse compilation stage of the first quantum computing task to obtain the executable pulse sequence of the first quantum computing task, based on operations of:
compiling the first quantum computing task by taking a full amount of bit resources in the quantum computing device as an available resource of the first quantum computing task, to obtain the executable pulse sequence of the first quantum computing task.

In some embodiments, each of the processing stages is executed using an independent thread.

In some embodiments, the processing stages include, in addition to the pulse compilation stage, at least one of:
a task obtaining stage, operable for obtaining a quantum computing task;
a communication phase, operable for communicating with a quantum computing device;
a post-processing stage, operable for performing a post-processing operation on a quantum computing result to obtain an execution result of the quantum computing task; or
a transmission stage, operable for transmitting the execution result of the quantum computing task to a cloud data center.

In some embodiments, where the plurality of processing stages include the task obtaining stage, the processing module 701 is configured to perform the task obtaining stage of the first quantum computing task based on operations of:
obtaining the first quantum computing task from the cloud data center;
sending a request for storing the first quantum computing task to a storage space of quantum computing task to a task manager;
receiving response information of the task manager to the request; and
sending, in the case where the response information indicates that the first quantum computing task is allowed to be stored, the first quantum computing task to the task manager to store the first quantum computing task in the storage space of quantum computing task.

In some embodiments, the processing module 701, in which the pulse compilation stage is performed on the first quantum computing task to obtain the executable pulse sequence of the first quantum computing task, specifically includes:
a first obtaining unit, configured to obtain the first quantum computing task from the storage space of quantum computing task;
a dividing unit, configured to divide the first quantum computing task into a plurality of subtasks;
a compiling unit, configured to compile each of the subtasks to obtain an original pulse sequence of each subtask; to compile the original pulse sequence of each subtask into the executable pulse sequence which can be recognized by the quantum computing device, based on an execution requirement of the quantum computing device; and
a storing unit, configured to store the executable pulse sequence of each subtask in a storage space of pulse.

In some embodiments, the storing unit is specifically configured to:
determine, for each subtask of the first quantum computing task, a sequence identifier of the executable pulse sequence of the subtask based on a task identifier of the first quantum computing task and a subtask identifier of the subtask; and
store the executable pulse sequence of the subtask and the corresponding sequence identifier in the storage space of the pulse controlled by a pulse sequence manager.

In some embodiments, where the processing stages include the communication stage, the processing module 701 is configured to perform the communication stage of the first quantum computing task based on operations of:
sending the executable pulse sequence of the first quantum computing task to the quantum computing device; and
receiving a quantum computing result of the first quantum computing task sent by the quantum computing device.

In some embodiments, the processing module 701 is specifically configured to determine that the quantum computing device completes the first quantum computing task upon receiving the quantum computing result of the first quantum computing task.

In some embodiments, where the processing stages include the communication stage, the processing module 701 is configured to perform the communication stage of the first quantum computing task based on operations of:
correspondingly storing the quantum computing result of the first quantum computing task and the task identifier of the first quantum computing task in the storage space of quantum computing result.

In some embodiments, the storage space of quantum computing result is controlled by a pulse manager.

In some embodiments, where the processing stages include the post-processing stage, the processing module 701 is configured to perform the post-processing stage of the first quantum computing task based on operations of
performing the post-processing operation on the quantum computing result of the first quantum computing task to obtain an execution result of the first quantum computing task; and
storing the execution result of the first quantum computing task and the corresponding task identifier in a storage space of execution result.

In some embodiments, the storage space of execution result is controlled by a task manager.

In some embodiments, the sending module 702 is specifically configured to:
send, in the case where the first quantum computing task includes a plurality of subtasks, executable pulse sequences of the subtasks to the quantum computing device one by one, wherein
in the case of it is determined that the quantum computing device has completed a previous subtask, an executable pulse sequence of a next subtask is sent to the quantum computing device.

In some embodiments, where the processing stages include the transmission stage, the processing module 701 includes the following units to perform the transmission stage of the first quantum computing task, which are:
a second obtaining unit, configured to obtain the execution result of the subtask in the first quantum computing task from the storage space of execution result; and
a transmission unit, configured to transmit the execution result of the subtask of the first quantum computing task to the cloud data center.

In some embodiments, the transmission unit is specifically configured to:
obtain the execution result of the subtask in the first quantum computing task from the storage space of execution result in the case where any one of the following sending conditions is met:
the number of execution results of the subtasks of the first quantum computing task in the storage space of execution result is greater than a number threshold; and
a time interval from the last sending of the execution result of the first quantum computing task to the cloud data center is greater than a time threshold.

In some embodiments, the processing module 701, in which the transmission stage is performed on the first quantum computing task, is further configured to:
send, in the case of detecting that the execution of the first quantum computing task is abnormal or in the case of it is determined that all the execution results of the first quantum computing task are sent to the cloud data center, a notification message to the cloud data center.

In some embodiments, a processing stage being performed for the second quantum computing task precedes a processing stage being performed for the first quantum computing task at a same moment.

Based on the same technical concept, an embodiment of the present disclosure also provides an apparatus for processing quantum computing tasks, as shown in FIG. 8, including:
a receiving module 801, configured to receive an executable pulse sequence of a first quantum computing task, wherein the first quantum computing task is divided into a plurality of processing stages based on a parallel pipeline mode, and the executable pulse sequence of the first quantum computing task is obtained by performing a pulse compiling stage of the plurality of processing stages; and
an execution module 802, configured to perform quantum computing on the first quantum computing task based on the executable pulse sequence of the first quantum computing task.

In some embodiments, during performing the quantum computing based on the executable pulse sequence of the first quantum computing task, compilation of an executable pulse sequence of a second quantum computing task has been completed based on the plurality of processing stages of the parallel pipeline mode.

The receiving module 801 is further configured to receive an executable pulse sequence of a second quantum computing task in the case where the executing of the executable pulse sequence of the first quantum computing task is completed;

The execution module 802 is further configured to perform quantum computing based on the executable pulse sequence of the second quantum computing task.

In some embodiments, the processing stages include, in addition to the pulse compilation stage, at least one of:
a task obtaining stage, operable for obtaining a quantum computing task;
a communication phase, operable for communicating with a quantum computing device;
a post-processing stage, operable for performing a post-processing operation on a quantum computing result to obtain an execution result of the quantum computing task; or
a transmission stage, operable for transmitting the execution result of the quantum computing task to a cloud data center.

For a description of specific functions and examples of each module and each sub-module of the apparatus in the embodiment of the present disclosure, reference may be made to the related description of the corresponding steps in the foregoing method embodiments, and details thereof are not repeated herein.

In the technical solution of the present disclosure, the acquisition, storage and application of the user's personal information involved are all in compliance with the provisions of relevant laws and regulations, and do not violate public order and good customs.

An aspect of the present disclosure also provides a non-transitory computer readable storage medium storing a computer instruction that, when executed by at least one quantum processing unit, causes the at least one quantum processing unit to perform the above method applied to a quantum computing device.

An aspect of the present disclosure also provides a computer program product including a computer program which, when executed by a processor, implements the above method applied to a classical computing device; or
which, when executed by at least one quantum processing unit, implements a method applied to a quantum computing device.

The present disclosure also provides a quantum computing device, comprising:
at least one quantum processing unit;
a memory, coupled to at least one QPU and operable to store an executable instruction,
the instruction is executable by the at least one quantum processing unit to enable the at least one quantum processing unit to perform a method applied to a quantum computing device.

It is to be understood that the quantum processing unit, which may also be referred to as a quantum processor or quantum chip, used in aspects of the present disclosure may refer to a physical chip that includes a plurality of qubits interconnected in a particular manner.

Moreover, it can be appreciated that the qubit of the aspects of the present disclosure can refer to a basic information unit of the quantum computing device. The qubit is contained in the QPU and generalize the concept of classical digital bits.

According to embodiments of the present disclosure, the present disclosure also provides a classic computing device (hereinafter, the classic computing device is specifically exemplified as an electronic device), a readable storage medium and a computer program product.

According to the embodiments of the present disclosure, the present disclosure also provides an electronic device, a readable storage medium and a computer program product.

FIG. 9 shows a schematic block diagram of an exemplary electronic device 900 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 9, the device 900 includes a computing unit 901 that may perform various appropriate actions and processes according to a computer program stored in a Read-Only Memory (ROM) 902 or a computer program loaded from a storage unit 908 into a Random Access Memory (RAM) 903. Various programs and data required for an operation of device 900 may also be stored in the RAM 903. The computing unit 901, the ROM 902 and the RAM 903 are connected to each other through a bus 904. The input/output (I/O) interface 905 is also connected to the bus 904.

A plurality of components in the device 900 are connected to the I/O interface 905, and include an input unit 906 such as a keyboard, a mouse, or the like; an output unit 907 such as various types of displays, speakers, or the like; the storage unit 908 such as a magnetic disk, an optical disk, or the like; and a communication unit 909 such as a network card, a modem, a wireless communication transceiver, or the like. The communication unit 909 allows the device 900 to exchange information/data with other devices through a computer network such as the Internet and/or various telecommunication networks.

The computing unit 901 may be various general-purpose and/or special-purpose processing components with processing and computing capabilities. Some examples of the computing unit 901 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 901 performs various methods and processing described above, such as the above method for processing quantum computing task. For example, in some implementations, the above method for processing quantum computing task can be implemented as a computer software program tangibly contained in a computer-readable medium, such as the storage unit 908. In some implementations, a part or all of the computer programs may be loaded and/or installed on the device 900 via the ROM 902 and/or the communication unit 909. When the computer program is loaded into RAM 903 and executed by the computing unit 901, one or more steps of the method for processing quantum computing task described above may be performed. Alternatively, in other implementations, the computing unit 901 may be configured to perform the above method for processing quantum computing task by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A method for processing quantum computing tasks, wherein each of a first quantum computing task and a second quantum computing task is divided into a plurality of processing stages, based on a parallel pipeline mode, the method comprising:
performing, in a case where the first quantum computing task is performed to a pulse compilation stage in the plurality of processing stages according to an order in which the plurality of processing stages are performed sequentially, the pulse compilation stage of the first quantum computing task, to obtain an executable pulse sequence of the first quantum computing task;
sending the executable pulse sequence of the first quantum computing task to a quantum computing device;
performing, according to the order in which the plurality of processing stages are performed sequentially, the second quantum computing task in parallel during performing the plurality of processing stages of the first quantum computing task, to obtain an executable pulse sequence of the second quantum computing task in a case of it is performed to the pulse compilation stage; and
sending, in a case of it is determined that the quantum computing device has completed the first quantum computing task, the executable pulse sequence of the second quantum computing task to the quantum computing device.

2. The method of claim 1, wherein performing the pulse compilation stage of the first quantum computing task to obtain the executable pulse sequence of the first quantum computing task comprises:
compiling the first quantum computing task by taking a full amount of bit resources in the quantum computing device as an available resource of the first quantum computing task, to obtain the executable pulse sequence of the first quantum computing task;
wherein each of the plurality of processing stages is executed using an independent thread.

3. The method of claim 1, wherein the plurality of processing stages further comprise, in addition to the pulse compilation stage, at least one of:
a task obtaining stage, operable for obtaining a quantum computing task;
a communication phase, operable for communicating with the quantum computing device;
a post-processing stage, operable for performing a post-processing operation on a quantum computing result to obtain an execution result of the quantum computing task; or
a transmission stage, operable for transmitting the execution result of the quantum computing task to a cloud data center.

4. The method of claim 3, wherein in a case where the plurality of processing stages include the task obtaining stage, performing the task obtaining stage of the first quantum computing task, comprises:
obtaining the first quantum computing task from the cloud data center;
sending a request for storing the first quantum computing task to a storage space of quantum computing task to a task manager;
receiving response information of the task manager to the request; and
sending, in a case where the response information indicates that the first quantum computing task is allowed to be stored, the first quantum computing task to the task manager to store the first quantum computing task in the storage space of quantum computing task.

5. The method of claim 1, wherein performing the pulse compilation stage of the first quantum computing task to obtain the executable pulse sequence of the first quantum computing task, comprises:
obtaining the first quantum computing task from a storage space of quantum computing task;
dividing the first quantum computing task into a plurality of subtasks;
compiling each of the plurality of subtasks to obtain an original pulse sequence of each subtask;
compiling the original pulse sequence of each subtask into the executable pulse sequence which is recognizable by the quantum computing device, based on an execution requirement of the quantum computing device; and
storing the executable pulse sequence of each subtask in a storage space of pulse.

6. The method of claim 5, wherein storing the executable pulse sequence of each subtask into the storage space of pulse comprises:
determining, for each subtask of the first quantum computing task, a sequence identifier of the executable pulse sequence of the subtask based on a task identifier of the first quantum computing task and a subtask identifier of the subtask; and
storing the executable pulse sequence of the subtask and the corresponding sequence identifier in the storage space of the pulse controlled by a pulse sequence manager.

7. The method of claim 3, wherein in a case where the plurality of processing stages include the communication stage, performing the communication stage of the first quantum computing task, comprises:
sending the executable pulse sequence of the first quantum computing task to the quantum computing device; and
receiving the quantum computing result of the first quantum computing task sent by the quantum computing device;
wherein determining that the quantum computing device has completed the first quantum computing task comprises:
upon receiving the quantum computing result of the first quantum computing task, determining that the quantum computing device has completed the first quantum computing task.

8. The method of claim 3, wherein in a case where the plurality of processing stages include the communication stage, performing the communication stage of the first quantum computing task, comprises:
storing the quantum computing result of the first quantum computing task and the task identifier of the first quantum computing task in a storage space of quantum computing result;
wherein the storage space of quantum computing results is controlled by a pulse manager.

9. The method of claim 3, wherein in a case where the plurality of processing stages include the post-processing stage, performing the post-processing stage of the first quantum computing task, comprises:
performing the post-processing operation on the quantum computing result of the first quantum computing task to obtain an execution result of the first quantum computing task; and
storing the execution result of the first quantum computing task and the corresponding task identifier in a storage space of execution result;
wherein the storage space of execution result is controlled by a task manager.

10. The method of claim 1, wherein sending the executable pulse sequence of the first quantum computing task to the quantum computing device, comprises:
sending, in a case where the first quantum computing task includes a plurality of subtasks, executable pulse sequences of the plurality of subtasks to the quantum computing device one by one,
wherein an executable pulse sequence of a next subtask is sent to the quantum computing device in a case of it is determined that the quantum computing device has completed a previous subtask.

11. The method of claim 3, wherein in a case where the plurality of processing stages include the transmission stage, performing the transmission stage of the first quantum computing task, comprises:
obtaining an execution result of a subtask of the first quantum computing task from the storage space of execution result; and
transmitting the execution result of the subtask of the first quantum computing task to the cloud data center;
wherein obtaining the execution result of the subtask of the first quantum computing task from the storage space of execution result comprises:
obtaining the execution result of the subtask of the first quantum computing task from the storage space of execution result in a case where any one of sending conditions is satisfied, in which:
a number of execution results of subtasks of the first quantum computing task in the storage space of execution result is greater than a number threshold; and
a time interval from a last sending of the execution result of the first quantum computing task to the cloud data center is greater than a time threshold.

12. The method of claim 11, wherein performing the transmission stage of the first quantum computing task, further comprises:
sending, in a case of it is detected that an execution of the first quantum computing task is abnormal or it is determined that all the execution results of the first quantum computing task are sent to the cloud data center, a notification message to the cloud data center.

13. The method of claim 1, wherein a processing stage being performed for the second quantum computing task precedes a processing stage being performed for the first quantum computing task at a same moment.

14. A method for processing quantum computing tasks, comprising:
receiving an executable pulse sequence of a first quantum computing task, wherein the first quantum computing task is divided into a plurality of processing stages based on a parallel pipeline mode, and the executable pulse sequence of the first quantum computing task is obtained by performing a pulse compiling stage of the plurality of processing stages; and
performing quantum computing on the first quantum computing task based on the executable pulse sequence of the first quantum computing task.

15. The method of claim 14, wherein compilation of an executable pulse sequence of a second quantum computing task has been completed, based on the plurality of processing stages of the parallel pipeline mode, during performing the quantum computing based on the executable pulse sequence of the first quantum computing task, further comprising:
receiving, in a case where executing of the executable pulse sequence of the first quantum computing task is completed, the executable pulse sequence of the second quantum computing task is; and
performing quantum computing based on the executable pulse sequence of the second quantum computing task.

16. The method of claim 14, wherein the plurality of processing stages further comprise, in addition to the pulse compilation stage, at least one of:
a task obtaining stage, operable for obtaining a quantum computing task;
a communication phase, operable for communicating with a quantum computing device;
a post-processing stage, operable for performing a post-processing operation on a quantum computing result to obtain an execution result of the quantum computing task; or
a transmission stage, operable for transmitting the execution result of the quantum computing task to a cloud data center.

17. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 1.

18. A quantum computing device, comprising:
at least one quantum processing unit QPU; and
a memory coupled to the at least one QPU and configured to store an executable instruction,
wherein the instruction is executable by the at least one QPU to enable the at least one QPU to execute the method of claim 14.

19. A non-transitory computer-readable storage medium storing a computer instruction thereon, wherein the computer instruction is used to cause a computer to execute the method of claim 1.

20. A non-transitory computer-readable storage medium storing a computer instruction thereon, wherein the computer instruction is used to cause a computer to execute the method of claim 14.
